(19) United States
(12) Patent Application Publication
(10) Pub. No.: US 2007/0192759 A1
(43) Pub. Date: Aug. 16, 2007

(54) Diagram editing apparatus

(75) Inventors: Toshinao Ishii, Tokyo (JP); Takayuki Yamaoka, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Electric Corporation, Tokyo (JP)

(21) Appl. No.: 11/482,754

(22) Filed: Jul. 10, 2006

(30) Foreign Application Priority Data
Feb. 14, 2006 (JP) 2006-036942

(51) Int. Cl. G06F 9/44

(52) U.S. Cl. 717/113

(57) ABSTRACT

A diagram editing apparatus includes a group establishing unit for establishing groups to which the model elements edited by a model element editor belong, respectively, and a structure space diagraming unit for determining an inclusion relationship among the groups established by the group establishing unit, and for displaying a structure space diagram showing the inclusion relationship among the groups.

### BACKGROUND OF THE INVENTION

1. Field of the Invention

The present invention relates to a diagram editing apparatus for supporting editing of a diagram in which a system which is the target of software development is modeled.

2. Description of Related Art

A related art diagram editing apparatus produces, as well as an editing window which is used for editing model elements which are components of a diagram, a tree view showing the package structure of the model elements edited using the editing window.

A connection relation between a plurality of model elements, i.e., the semantics of the diagram is clearly shown in the editing window of the diagram editing apparatus. However, when there are a large number of model elements which constitute the diagram, the related art diagram editing apparatus cannot display all model elements at a time and hence it is difficult for the user to grasp the entire configuration of the diagram.

On the other hand, when the display area of each model element is made small, the whole diagram can be displayed, but in this case it is difficult for the user to recognize each model element and it is therefore difficult for the user to grasp the entire configuration of the diagram.

Although the semantics of the diagram is displayed in the editing window of the diagram editing apparatus, since the related art diagram editing apparatus includes neither a function of grouping the model elements edited using the editing window, nor a function of specifying an inclusion relation among the model elements, the user cannot grasp the structure of the diagram from a point of view different from the semantics of the diagram.

The following patent reference 1 discloses a program specification generation method having a function of, in order to facilitate modification and reuse of an existing program, analyzing the existing program and extracting a program processing pattern, which is called a skeletal structure, from the existing program, and a function of changing the skeletal structure according to the user' s request, and then generating a program automatically. However, the program specification generation method disclosed by patent reference 1 has neither a function of grouping model elements edited using an editing window, nor a function of specifying an inclusion relation among the model elements.

[Patent reference 1] JP,5-40616,A (refer to paragraph [0012] and FIG. 1)

A problem with the related art diagram editing apparatus constructed as mentioned above is that it is difficult for the user to grasp the entire configuration of the diagram when there are a large number of model elements which constitute the diagram.

Another problem is that although the user can grasp the structure of the diagram from the viewpoints of the semantics of the diagram by watching the editing window, the user cannot grasp the structure of the diagram from a point of view different from the semantics of the diagram.

### SUMMARY OF THE INVENTION

The present invention is made in order to solve the above-mentioned problems, and it is therefore an object of the present invention to provide a diagram editing apparatus which, even when there are a large number of model elements which constitute a diagram, enables the user to grasp the entire configuration of the diagram easily, and to grasp the structure of the diagram from a point of view different from the semantics of the diagram.

In accordance with the present invention, there is provided a diagram editing apparatus including a group establishing unit for establishing groups to which the model elements edited by a model element editing unit belong, respectively, and a structure space diagrammatizing unit for determining a relation among the plurality of groups established by the group establishing unit, and for displaying a structure space diagram showing the relation among the plurality of groups.

Therefore, the present invention offers an advantage of being able to enable the user to grasp the entire configuration of the diagram easily even when there is a large number of model elements which constitute the diagram, and being able to enable the user to grasp the structure of the diagram from a point of view different from the semantics of the diagram.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a diagram editing apparatus in accordance with embodiment 1 of the present invention;

FIG. 2 is a flow chart showing processing carried out by the diagram editing apparatus in accordance with embodiment 1 of the present invention;

FIG. 3 is a diagram showing an editing window E, a structural element viewing-window S, and so on;

FIG. 4 is a diagram showing an editing window E, a structural element viewing-window S, and so on;

FIG. 5 is a block diagram showing a diagram editing apparatus in accordance with embodiment 3 of the present invention;

FIG. 6 is a diagram showing an example of a structural element operator;

FIG. 7 is a diagram showing a state in which the structural element operator is imported;

FIG. 8 is a diagram showing an example of creation of a model element;

FIG. 9 is a block diagram showing a diagram editing apparatus in accordance with embodiment 5 of the present invention;

FIG. 10 is a diagram showing a star-type model structure;

FIG. 11 is a diagram showing a collapsed-star-type model structure; and

FIG. 12 is a diagram showing model semantics and structure space.

### DETAILED DESCRIPTION OF THE PREFERRED EMBODIMENTS

### Embodiment 1

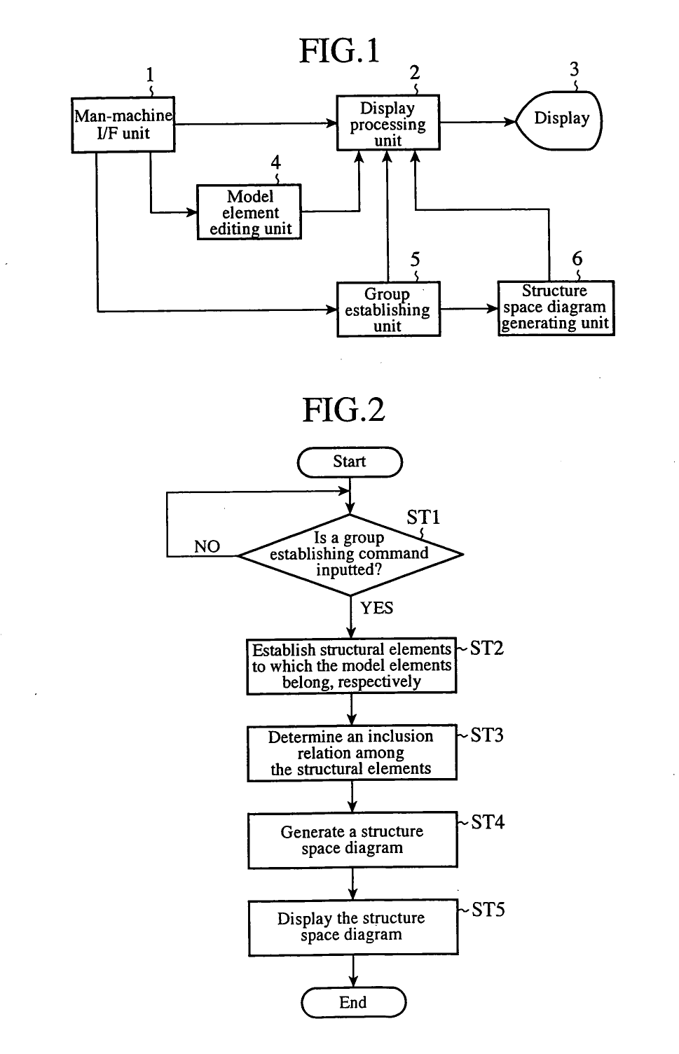

FIG. 1 is a block diagram showing a diagram editing apparatus in accordance with embodiment 1 of the present invention. In the figure, a man-machine I/F unit 1 is provided with a keyboard, a mouse, or the like, and, for example, it is an input device for accepting an editing command for editing model elements, a group establishing command for establishing groups to which the model elements belong, respectively, or the like.

A display processing unit 2 carries out a process of displaying an editing window E which is used when editing model elements which are components of a diagram, a pallet P which is used when selecting parts of model elements which are to be arranged in the editing window E, a tree view B in which the package structure of the model elements edited using the editing window E is shown, a structural element viewing-window S in which structural elements each of which is a subset of model elements which constitute the diagram (i.e., a set of model elements belonging to an identical group) are displayed, etc. on a display 3.

A model element editing unit 4 carries out a process of editing model elements which are components of the diagram in the editing window E displayed by the display processing unit 2 according to an editing command furnished from the man-machine I/F unit 1.

A model element editing means includes the display processing unit 2 and model element editing unit 4.

A group establishing unit 5 carries out a process of establishing groups to which the model elements edited by the model element editing unit 4 belong, respectively, in the editing window E displayed by the display processing unit 2 according to the group establishing command furnished from the man-machine I/F unit 1. In other words, the group establishing unit carries out a process of establishing structural elements each of which is a subset of model elements which constitute the diagram.

A group establishing means includes the display processing unit 2 and group establishing unit 5.

A structure space diagram generating unit 6 carries out a process of determining, as a relation among the structural elements (i.e., among the groups) established by the group establishing unit 5, an inclusion relation among the structural elements (i.e., among the groups), generating a structure space diagram showing the inclusion relation among the structural elements, and displaying the structure space diagram in the structural element viewing-window S by way of the display processing unit 2.

A structure space diagrammatizing means includes the display processing unit 2 and structure space diagram generating unit 6.

FIG. 2 is a flow chart showing processing carried out by the diagram editing apparatus in accordance with embodiment 1 of the present invention.

In the example of FIG. 1, it is assumed that the display processing unit 2, model element editing unit 4, group establishing unit 5, and structure space diagram generating unit 6 which are the components of the diagram editing apparatus are constructed of special-purpose hardware (e.g., an integrated circuit substrate on which an MPU is mounted). When the diagram editing apparatus is constructed of a computer, a program in which the processing carried out by the display processing unit 2, model element editing unit 4, group establishing unit 5, and structure space diagram generating unit 6 which are the components of the diagram editing apparatus is described can be stored in a memory of the computer, and a CPU of the computer can be made to execute the program stored in the memory.

Next, the operation of the diagram editing apparatus in accordance with this embodiment of the present invention will be explained.

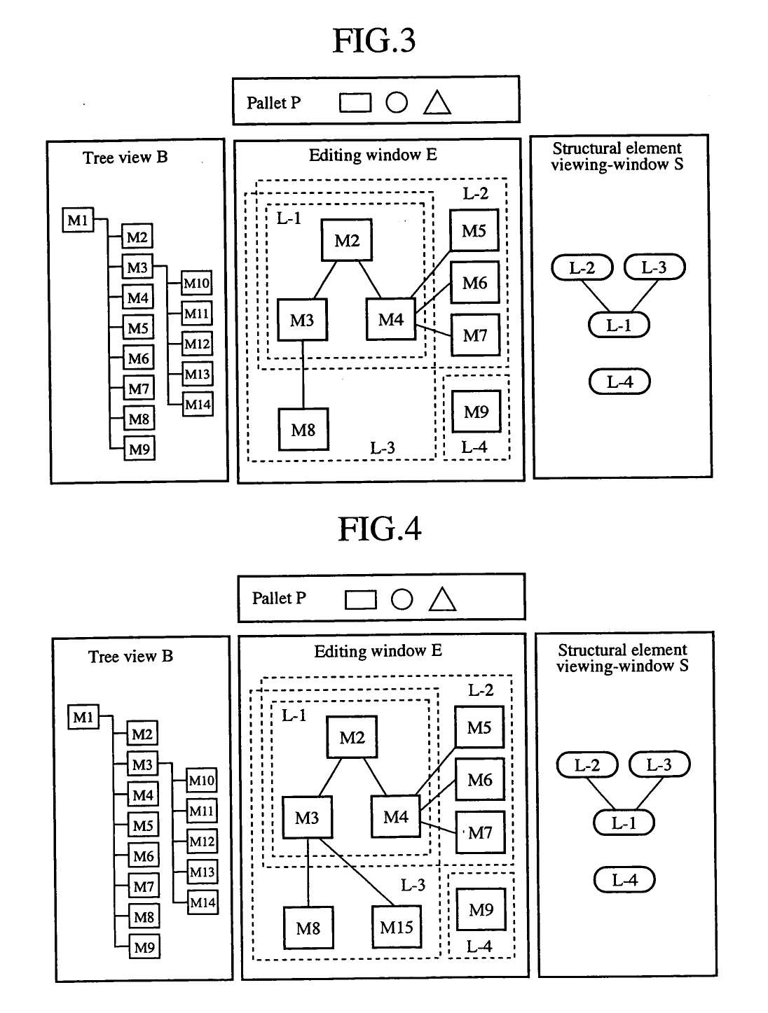

As shown in FIG. 3, the display processing unit 2 displays the editing window E which is used when editing a plurality of model elements which are components of the diagram, the pallet P which is used when selecting parts of model elements which are to be arranged in the editing window E, the tree view B in which the package structure of the model elements edited using the editing window E is shown, the structural element viewing-window S in which structural elements each of which is a subset of model elements which constitute the diagram are shown on the display 3.

In the example of FIG. 3, the diagram consists of 14 model elements M1 to M14, and the package structure of the 14 model elements M1 to M14 is displayed in the tree view B.

Furthermore, in the example of FIG. 3, the model elements M2 to M9 which are hanging down from the top model element M1 of the diagram are displayed in the editing window E.

The model element M2 is connected to the model elements M3 and M4, the model element M4 is connected to the model elements M5, M6, and M7, and the model element M3 is connected to the model element M8. The model element M9 is not connected to any other model elements, and is independently disposed. Therefore, in the example of FIG. 3, it can be expected that the model elements M2 to M9 are executed in order as shown below. Model elements in the same level are processed in parallel (e.g. the model elements M3 and M4 are processed in parallel). However, this order is an example, and the model elements can be executed in other order.

| First Turn | Second Turn | Third Turn |
|---|---|---|
| Model element M2 | Model element M3 | Model element M8 |
| | Model element M4 | Model element M5 |
| | | Model element M6 |
| | | Model element M7 |
| Model element M9 | | |

In general, the model elements M2 toM9 carry out different processes. For example, semantics which carries out processing independently in response to a processing result from an identical model element can be described as each of those model elements.

For example, the model elements M5 to M7 can be model elements each of which carries out processing independently in response to a processing result from the same model element M4.

In such a case, when the model elements M5 to M7 are grouped so as to belong to an identical group (i.e., an identical structural element), the plurality of model elements M5 to M7 can be managed as one structural element L-2.

When the diagram editing apparatus of this embodiment 1 is applied to a field of object oriented analysis, each model element can represent an object shown by a software program (e.g., an object which the user or the programmer can recognize). To be more specific, each model element represents a class, an object, or the like.

When the user desires to group the model elements M1 to M14, he or she operates the man-machine I/F unit 1 so as to input a group establishing command for establishing groups to which the model elements belong, respectively.

When the user operates the man-machine I/F unit 1 so as to input the group establishing command (in step ST1), the group establishing unit 5 carries out a process of establishing groups (i.e., structural elements) to which the model elements M2 to M9 belong, respectively, according to the group establishing command in the editing window E displayed by the display processing unit 2 (in step ST2).

Each dotted line of FIG. 3 shows model elements which belong to a group (i.e., a structural element) established by the group establishing unit 5.

A plurality of structural elements are established so that the model elements M2, M3, and M4 belong to a structural element L-1, the model elements M2, M3, M4, M5, M6, and M7 belong to a structural element L-2, the model element M2, M3, M4, and M8 belong to a structural element L-3, and the model element M9 belongs to a structural element L-4.

Therefore, in the example of FIG. 3, an inclusion relation as shown below is established among the plurality of structural elements L-1, L-2, L-3, and L-4. Hereafter, A>B means that A includes B.

L-2>L-1

L-3>L-1

L-4 has no inclusion relation

When the group setting unit 5 establishes the plurality of structural elements L-1, L-2, L-3, and L-4 to which the model elements M2 to M9 belong, respectively, the structure space diagram generating unit 6 carries out a process of determining an inclusion relation among the plurality of structural elements L-1, L-2, L-3, and L-4 (in step ST3).

In other words, the structure space diagram generating unit 6 compares the model elements which belong to the plurality of structural elements L-1, L-2, L-3, and L-4, respectively, with one another so as to determine an inclusion relation among the plurality of structural elements L-1, L-2, L-3, and L-4.

For example, since the model elements M2, M3, and M4 belong to the structural element L-1 while all of the model elements M2, M3, and M4 belonging to the structural element L-1, as well as the model elements M5, M6, and M7, belong to the structural element L-2, the structure space diagram generating unit determines that the structural element L-2 includes the structural element L-1.

When determining an inclusion relation among the plurality of structural elements L-1, L-2, L-3, and L-4, the structure space diagram generating unit 6 generates a structure space diagram showing the inclusion relation among the plurality of structural elements L-1, L-2, L-3, and L-4 (in step ST4).

When the structure space diagram generating unit 6 generates the structure space diagram, the display processing unit 2 displays the structure space diagram in the structural element viewing-window S, as shown in FIG. 3 (in step ST5).

Next, a process of newly adding a model element will be explained. For convenience in description, an example in which a model element M15 is added to the structural element L-3 will be explained.

In this case, the user operates the man-machine I/F unit 1 so as to select a desired part from the parts of the model elements currently being displayed in the pallet P. When the user selects a part □, the model element M15 which is □ is arranged in the editing window E, or, when the user selects a part Δ, the model element M15 which is Δis arranged in the editing window E, as will be mentioned below.

Next, when the user operates the man-machine I/F unit 1 so as to select the structural element L-3 which is displayed in the structural element viewing-window S, the model element editing unit 4 arranges the new model element M15 in the region of the structural element L-3, as shown in FIG. 4.

At that time, since the model element M8 belonging to the structural element L-3 is connected to the model element M3, the model element editing unit automatically edits the model element M15 which is newly arranged so that it is connected to the model element M3, like the model element M8.

The connection relation between the model element M15 and the model element M3 is set by the model element editing unit 4 as both an attribute of the model element M15 and an attribute of the model element M3. As an alternative, the connection relation between the model element M15 and the model element M3 can be set as an attribute of a connection line connecting between the model element M15 and the model element M3.

Information indicating that the model element M15 belongs to the structural element L-3 is also set as an attribute of the model element M15.

As can be seen from the above description, the diagram editing apparatus in accordance with this embodiment 1 is provided with the group setting unit 5 for establishing a plurality of structural elements to which model elements edited by the model element editing unit 4 belong, respectively, and is so constructed as to determine an inclusion relation among the plurality of structural elements established by the group setting unit 5, and to display a structure space diagram showing the inclusion relation among the plurality of structural elements. Therefore, the present embodiment offers an advantage of being able to enable the user to grasp the entire configuration of the diagram easily even when there is a large number of model elements which constitute the diagram, and being able to enable the user to grasp the structure of the diagram from a point of view different from the semantics of the diagram shown in the editing window E.

In other words, the present embodiment offers an advantage of being able to enable the user to grasp the entire configuration of the diagram easily since a plurality of model elements can be managed as one structural element even when there are a large number of model elements which constitute the diagram.

Furthermore, the present embodiment offers another advantage of being able to enable the user to grasp the structure of the diagram from a point of view different from the semantics shown in the editing window E since the plurality of model elements can be grouped from a point of view different from the semantics.

In this embodiment 1, one or more model elements which belong to each of the plurality of structural elements established by the group setting unit 5 are enclosed by a dotted line (see FIG. 3). As an alternative, one or more model elements which belong to each of the plurality of structural elements established by the group setting unit can be distinguished from other model elements using, for example, color-coding or variations in fill pattern.

In accordance with this embodiment 1, the structure space diagram generating unit 6 determines, as information indicating a relation among the plurality of structural elements established by the group setting unit 5, an inclusion relation among the plurality of structural elements, as previously mentioned. The structure space diagram generating unit 6 does not restrict the information indicating a relation among the plurality of structural elements established by the group setting unit 5 to the inclusion relation among the plurality of structural elements.

For example, when the structural element L-1 is connected to the structural element L-2, the structure space diagram generating unit 6 determines, as the information indicating a relation among the plurality of structural elements, a communication relation between the structural element L-1 and the structural element L-2, a relation in which the structural element L-1 refers to information about the structural element L-2, a relation in which the structural element L-1 writes information in the structural element L-2, a relation in which the structural element L-1 has the structural element L-2 as a part thereof, a relation in which the structural element L-1 is a general form of the structural element L-2, or the like, and generates and displays a structure space diagram showing such a relation among the plurality of structural elements.

### Embodiment 2

In accordance with above-mentioned embodiment 1, the display processing unit 2 displays model elements edited by the model element editing unit 4 in the editing window E, as previously mentioned. In contrast, in accordance with this embodiment 2, when the user operates the man-machine I/F unit 1 to select an arbitrary structural element which is displayed in the structural element viewing-window S, the display processing unit 2 visually enhances model elements belonging to the selected structural element as compared with any other model elements belonging to structural elements which are not selected.

To be more specific, the display processing unit highlights model elements belonging to the selected structural element as follows.

When the user operates the man-machine I/F unit 1 to select, for example, a structural element L-1 from among a plurality of structural elements L-1 to L-4 which are displayed in the structural element viewing-window S, the display processing unit 2 highlights model elements M2, M3, and M4 belonging to the selected structural element L-1.

On the other hand, the display processing unit 2 controls the display of the other model elements M5 to M9 which do not belong to the selected structural element L-1 so that they are displayed inconspicuously.

As a technique for enhancing specific model elements visually, there can be provided a method of enlarging the display areas of the selected model elements, changing the foreground color of the selected model elements to a conspicuous color, or changing the display positions of the selected model elements to the center of the screen, for example.

On the other hand, as a technique for displaying not-selected model elements inconspicuously, there can be provided a method of reducing the display areas of the not-selected model elements, changing the foreground color of the not-selected model elements to a restrictive color, such as black or white, or a light color, or changing the display positions of the not-selected model elements to a corner of the screen, for example.

As can be seen from the above description, in accordance with this embodiment 2, when the user operates the man-machine I/F unit 1 so as to select an arbitrary structural element which is displayed in the structural element viewing-window S, the display processing unit 2 enhances the display of model elements belonging to the selected structural element visually as compared with the display of any other model elements belonging to structural elements which are not selected. Therefore, the present embodiment offers an advantage of being able to enable the user to promptly recognize the model elements belonging to the structural element currently being selected.

### Embodiment 3

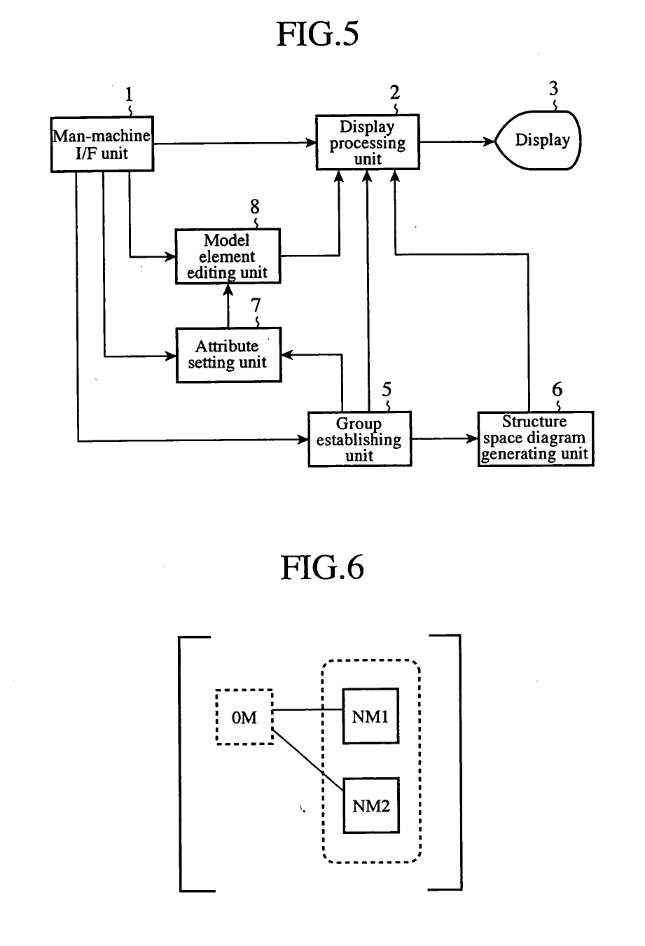

FIG. 5 is a block diagram showing a diagram editing apparatus in accordance with embodiment 3 of the present invention, and in the figure, since the same reference numerals as shown in FIG. 1 denote the same components or like components, the explanation of these components will be omitted hereafter.

An attribute setting unit 7 carries out a process of setting an attribute indicating whether or not each model element belonging to a structural element established by a group establishing unit 5 is an indispensable component. The attribute setting unit 7 constitutes an attribute setting means.

A model element editing unit 8 carries out the same processing as that carried out by the model element editing unit 4 of FIG. 1, and also prohibits editing aimed at deletion of a model element to which an attribute indicating that the model element is an indispensable component is set by the attribute setting unit 7.

The model element editing unit 8 also carries out a process of explicitly showing the attribute of a model element which is set by the attribute setting unit 7 by way of a display processing unit 2.

A model element editing means includes the model element editing unit 8.

Next, the operation of the diagram editing apparatus in accordance with this embodiment of the present invention will be explained.

Hereafter, for convenience in description, attention is focused on model elements M5, M6, and M7 belonging to a structural element L-2, and it is assumed that in an initial state, each of the model elements M5, M6, and M7 has an attribute indicating that itself is not an indispensable component.

An example in which the attribute of each of the model elements M5 and M6 which are selected from the model elements M5, M6, and M7 belonging to the structural element L-2 is changed so that the attribute indicates that each of the model elements M5 and M6 is an indispensable component will be explained.

In this case, the user operates a man-machine I/F unit 1 so as to select the structural element L-2 currently being displayed in the structural element viewing-window S, and also select the model elements M5 and M6 currently being displayed in the editing window E.

When the user then operates the man-machine I/F unit 1 so as to input a command indicating that the model elements M5 and M6 are indispensable components, the attribute setting unit 7 changes the attribute of each of the model elements M5 and M6 so that the attribute indicates that each of the model elements is an indispensable component.

While the model element editing unit 8 displays the model elements M2 to M9 in the editing window E by way of the display processing unit 2, like the model element editing unit 4 of FIG. 1, when the attribute setting unit 7 changes the attribute of each of the model elements M5 and M6, as mentioned above, the model element editing unit 8 explicitly shows the attribute of each of the model elements set by the attribute setting unit 7 so that the user can recognize that the model elements M5 and M6 are indispensable components .

To be more specific, the model element editing unit 8 displays the model elements M5 and M6 in a specific color (for example, when the model element editing unit 8 is preset so as to display model elements in red when they are indispensable components, and to display model elements in blue when they are not indispensable components, the model element editing unit 8 displays the model elements M5 and M6 in red).

For example, when the user operates the man-machine I/F unit 1 so as to input a deletion command for deleting the model element M7, the model element editing unit 8 accepts the deletion command for deleting the model element M7, and deletes the model element M7 from the editing window E.

However, after the attribute of each of the model elements M5 and M6 is changed as mentioned above, even when the user operates the man-machine I/F unit 1 so as to input a deletion command for deleting the model element M5 or M6, the model element editing unit 8 does not accept the deletion command for deleting the model element M5 or M6 as long as the structural element L-2 to which the model elements M5 and M6 belong exists.

As can be seen from the above description, the diagram editing apparatus in accordance with this embodiment 3 includes the attribute setting unit 7 for setting an attribute indicating whether or not each model element belonging to a structural element established by the group establishing unit 5 is an indispensable component. Therefore, the present embodiment offers an advantage of being able to provide a function of restricting the semantics of the model elements to the model element editing unit 8 which is a diagram editor.

Furthermore, the diagram editing apparatus in accordance with this embodiment 3 is so constructed as to prohibit editing aimed at deletion of any model element to which an attribute indicating that the model element is an indispensable component is set by the attribute setting unit 7. Therefore, the present embodiment offers another advantage of being able to prevent editing which is against the semantics of the model elements from being carried out.

In addition, the diagram editing apparatus in accordance with this embodiment 3 is so constructed as to explicitly show the attribute of each model element set by the attribute setting unit 7. Therefore, the present embodiment offers a further advantage of being able to enable the user to easily check to see whether or not each model element is an indispensable component.

In accordance with this embodiment 3, the attribute setting unit 7 sets an attribute indicating whether or not each model element belonging to a structural element established by the group establishing unit 5 is an indispensable component to each model element, as previously mentioned. The present invention is not limited to this example. For example, the attribute setting unit 7 can set an internal variable of each model element, a processing method which each model element has, or the like, and can impose restrictions upon the internal variable, processing method, or the like of each model element.

In addition, the diagram editing apparatus in accordance with this embodiment 3 allows the user to operate the man-machine I/F unit 1 so as to select a structural element currently being displayed in the structural element viewing-window S, and to select model elements currently being displayed in the editing window E, as previously mentioned. As an alternative, the diagram editing apparatus in accordance with this embodiment 3 can allow the user to operate the man-machine I/F unit 1 so as to specify connection lines between two structural elements and to specify a connection line between two model elements which is one of the specified connection lines between the two structural elements, and the attribute setting unit 7 can set an attribute indicating whether or not the connection line between the two model elements is an indispensable connection line. For example, the user to operate the man-machine I/F unit 1 so as to specify connection lines between the two structural elements L-1 and L-3 and to specify a connection line between the two model elements M3 and M8 which is one of the specified connection lines between the two structural elements, and the attribute setting unit 7 sets an attribute indicating whether or not the connection line between the two model elements M3 and M8 is an indispensable connection line according to the user's input operation.

In this case, when an attribute indicating that the connection line between the model elements M3 and M8 is an indispensable connection line is set, even if the user operates man-machine I/F unit 1 so as to input a deletion command for deleting the connection line between the model elements M3 and M8, the model element editing unit 8 does not accept the deletion command for deleting the connection line between the model elements M3 and M8 as long as there are connection lines between the structural elements L-1 and L-3.

### Embodiment 4

In above-mentioned embodiments 1 to 3, although no mention is made, when a structural element operator (or model template) in which model elements which are indispensable components, and a connection relation between the indispensable model elements and other model elements are defined is specified, the model element editing unit 8 can edit model elements in the editing window E according to the description defined in the structural element operator.

To be more specific, the model element editing unit 8 edits model elements as follows.

FIG. 6 is a diagram showing an example of the structural element operator. In the figure, NM1 and NM2 are model elements which are indispensable to a structural element which is newly added, and OM is a model element which is the target to which the model elements NM1 and NM2 are connected.

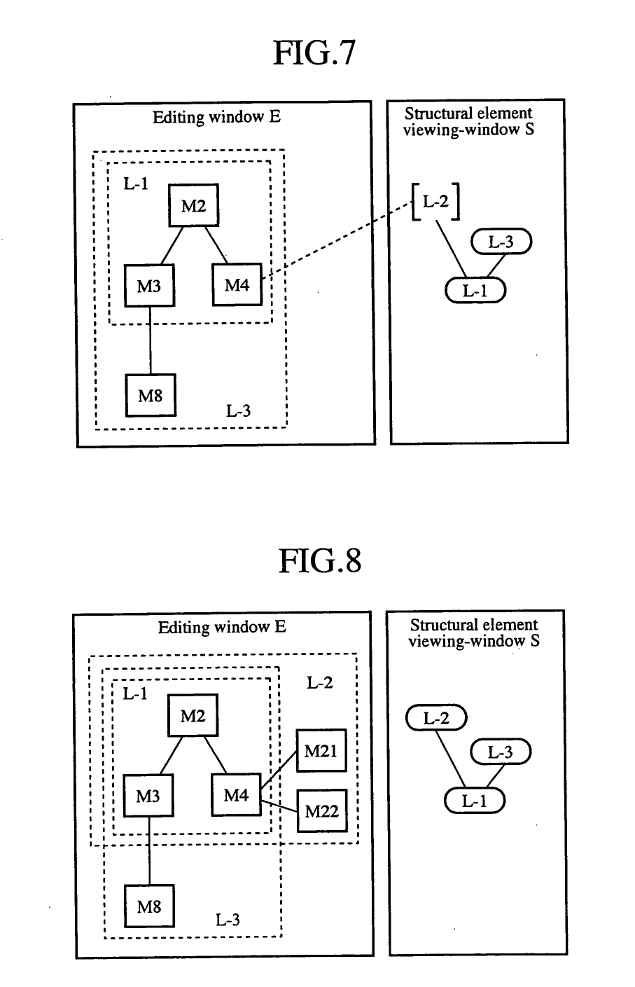

Hereafter, a procedure for generating a model element in the editing window E of FIG. 7 using the structural element operator of FIG. 6 will be explained.

For convenience in description, assume that structural elements L-1 and L-3 are already defined, model elements M2, M3, M4, and M8 are already generated, a structural element L-2 will be newly defined, and model elements M21 and M22 will be generated.

First, the user operates the man-machine I/F unit 1 to specify a structural element operator which he or she uses. In this case, assume that the user specifies the structural element operator shown in FIG. 6.

When the user specifies the structural element operator shown in FIG. 6, the model element editing unit 8 imports, as a structural element L-2, the structural element operator of FIG. 6 to the structural element viewing-window S of FIG. 7.

When the user further operates the man-machine I/F unit 1 so as to specify the connection destination of the structural element L-2 (in the example of FIG. 7, the structural element L-1 is the connection destination ), the model element editing unit 8 connects the structural element L-2 to the structural element L-1, as shown in FIG. 8.

When connecting the structural element L-2 to the structural element L-1 as mentioned above, the model element editing unit 8 generates, as model elements M21 and M22, two model elements NM1 and NM2 in the editing window E since the structural element operator of FIG. 6 has the two model elements NM1 and NM2 as indispensable model elements.

Furthermore, in the structural element operator of FIG. 6, since the indispensable model elements NM1 and NM2 are defined so that they are connected to the model element OM included in another structural element and that the structural element L-2 is connected to the structural element L-1 is described, the model element editing unit 8 connects the model elements M21 and M22 which are the indispensable model elements NM1 and NM2 to the model element M4 of the structural element L-1 (in the example of FIG. 8, it is assumed that the user operates the man-machine I/F unit 1 so as to specify the model element M4 of the structural element L-1 as the connection destination of the model elements M21 and M22).

As can be seen from the above description, in accordance with this embodiment 4, when a structural element operator in which a connection relation between an indispensable model element NM and another model element OM associated with the indispensable model element NM is defined is specified, the model element editing unit 8 edits the model elements in the editing window E according to the description defined in the structural element operator. Therefore, the present embodiment offers an advantage of being able to generate a new model element promptly.

### Embodiment 5

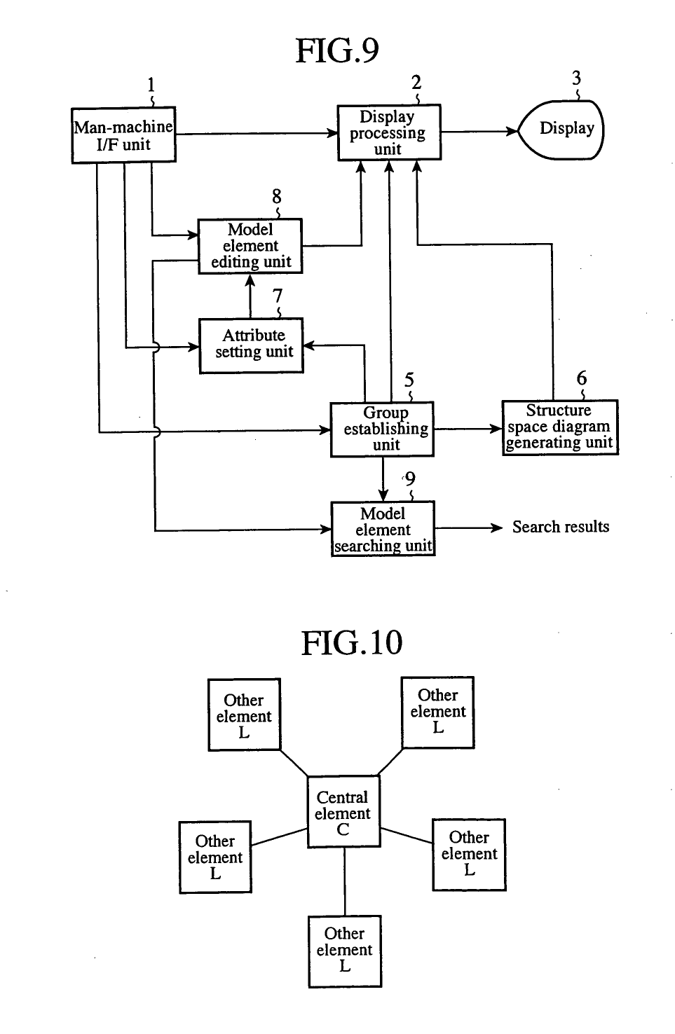

FIG. 9 is a block diagram showing a diagram editing apparatus in accordance with embodiment 5 of the present invention, and in the figure, since the same reference numerals as shown in FIG. 5 denote the same components or like components, the explanation of these components will be omitted hereafter.

A model element searching unit 9 carries out a process of searching for a model element which belongs to a structural element established by a group establishing unit 5 from among model elements edited by a model element editing 8. A model element searching means includes a model element searching unit 9.

The diagram editing apparatus in accordance with this embodiment 5 additionally has a function of, when searching for a desired model element from among the model elements edited by the model element editing 8, not only carrying out the searching from the viewpoints of the semantics of the diagram, but also searching for the desired model element on a structural-element-by-structural-element.

To be more specific, the diagram editing apparatus carries out the searching as follows.

In order to implement management of a data set, especially a function of searching for specific data from the data set, it is necessary to systematize the data set. This is because when the user desires to find out data which matches his or her purpose from a vast volume of data set, since it takes much time to check all the data included in the data set and it is therefore difficult to check all the data in reality, it is necessary to narrow down the number of data to check to see, and the system of the data can be used for this narrowing down.

For example, in Japanese dictionaries, the order of Japanese words is systematized so that they appear in order of the Japanese syllabary. Therefore, when the user opens an arbitrary page of a Japanese dictionary after determining a word to find out, he or she can know whether the word is located before or behind the page.

Therefore, every time when the user opens a page of the Japanese dictionary, he or she can narrow down the number of words to check to see to about one-half of the previous number of words to check to see. That is, in Japanese dictionaries, since the order of Japanese words is systematized so that they appear in order of the Japanese syllabary, the speed with which the target word is found out can be increased.

When management of the diagram and searching of data are performed, the efficiency of searching can be improved by storing data on the basis of a certain system, as in the case of Japanese words. However, it is not obvious to make the system of the diagram.

For example, although a case where the diagram is systematized using the names of the model elements can be considered, the name which is given to each model element changes according to the target to be modeled.

In an example of FIG. 10, a star-type model structure in which all other elements L are connected to a central element C so that each of all the other elements L has a one-to-one correspondence with the central element C is shown.

Even if the target to be modeled has a star-type model structure, the target to be modeled can have model elements having various names such as “class teacher” and “supplies of classroom materials”, or “network hub” and “types of computers connected to network”. Therefore, it is understood that the systematization of the target to be modeled using the names of the model elements is not helpful to searching by focusing attention on the structure of the model elements.

Next, the systematization of the target to be modeled by focusing attention on the structure of the model elements will be explained.

When the above-mentioned star structure is taken as an example, the central element C is uniquely determined while one or more other elements L are provided. Therefore, when it is determined that the model elements include a unique central element C and one or more other elements L, it can be considered that the model elements have a star structure. Therefore, the process of judging whether or not the model elements have a star structure takes more time and effort as the number of the model elements increases.

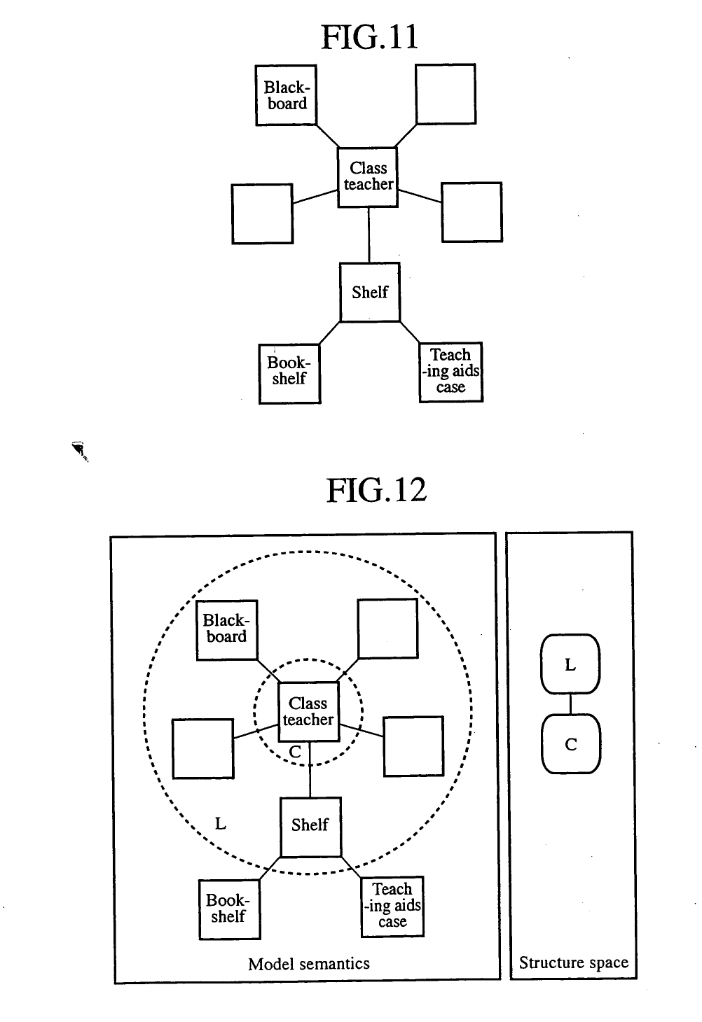

Even when there is a diagram which should be incorporated, as part of the star structure, into the systematization, any new model element cannot be added to an arbitrary model element. This is because the star structure collapses due to the establishment of a correlation between arbitrary model elements, such as “bookshelf” and “teaching aids case” and another model element L in the star structure, such as “shelf, as shown in FIG. 11.

This means that there easily occur conditions where the semantics of the model elements and the efficiency of the management of the diagram are incompatible with each other.

In contrast, in accordance with this embodiment, the systematization is carried out so that while the central one C of the model elements is associated with a structural element C in the structure space (i.e., a structural element to which the central element C belongs), other model elements L connected to the central one C of the model elements are associated with a structural element L in the structure space (i.e., a structural element L to which the other model elements L belong), as shown in FIG. 12. In this case, the establishment of a correlation between arbitrary model elements, such as “bookshelf” and “teaching aids case” and another model element L, such as “shelf”, does not change the configuration of the structure space even if the star structure collapses due to the establishment of the correlation.

For example, the use of correspondence information indicating a correspondence between the structural element L and the other model elements L makes it possible to distinguish a model element contained in the model elements in the star structure from other model elements which are not contained in the model elements in the star structure even if arbitrary model elements are associated with a model element in the star structure.

Therefore, this means that the diagram editing apparatus can search for a desired model element promptly only by checking the model elements belonging to the structural element even if some change is made to the star structure.

Thus, in accordance with this embodiment 5, when searching for a desired model element, the model element searching unit 9 searches through the model elements which are edited by the model element editing unit 8 and which belong to the structural elements established by the group establishing unit 5 with reference to a correspondence between the structural elements and the model elements.

Many widely different embodiments of the present invention may be constructed without departing from the spirit and scope of the present invention. It should be understood that the present invention is not limited to the specific embodiments described in the specification, except as defined in the appended claims.

1. A diagram editing apparatus comprising:
model element editing means for editing model elements which are components of a diagram;
group establishing means for establishing a plurality of groups to which the model elements edited by said model element editing means respectively belong; and
structure space diagraming means for determining a relationship among the plurality of groups established by said group establishing means, and for displaying a structure space diagram showing the relationship among the plurality of groups.

2. The diagram editing apparatus according to claim 1, wherein said structure space diagraming means determines, as the relationship among the plurality of groups established by said group establishing means, an inclusion relationship among the plurality of groups, and displays a structure space diagram showing the inclusion relationship among the plurality of groups.

3. The diagram editing apparatus according to claim 1, wherein, when a group in the structure space diagram currently being shown by said structure space diagraming means is specified, said model element editing means enhances one or more model elements belonging to the group specified visually, as compared with any other model elements which do not belong to the group specified.

4. The diagram editing apparatus according to claim 1, wherein said diagram editing apparatus further includes an attribute setting means for setting an attribute indicating whether or not each of the model elements belonging to one of the groups established by said group establishing means is an indispensable component.

5. The diagram editing apparatus according to claim 4, wherein said model element editing means prohibits editing aimed at deletion of any model element to which an attribute indicating that the model element is an indispensable component has been set by said attribute setting means.

6. The diagram editing apparatus according to claim 4, wherein said model element editing means explicitly shows the attribute which is set to each of the model elements by said attribute setting means.

7. The diagram editing apparatus according to claim 1, wherein, when a model template, which defines a connection relationship between a model element which is an indispensable component and another one of the model elements, is specified, said model element editing means editing the model element according to the model template.

8. The diagram editing apparatus according to claim 1, wherein said diagram editing apparatus further includes a model element searching means for searching for a model element which belongs to one of the groups established by said group establishing means from among the model elements edited by said model element editing means.
